(19) United States
(12) Patent Application Publication
(10) Pub. No.: US 2021/0171046 A1
(43) Pub. Date: Jun. 10, 2021

(54) METHOD AND VEHICLE SYSTEM FOR PASSENGER RECOGNITION BY AUTONOMOUS VEHICLES

(71) Applicant: ROBERT BOSCH GMBH, Stuttgart (DE)

(72) Inventors: Gregor BLOTT, Salzgitter (DE); Robert BORCHERS, Bretten (DE)

(73) Assignee: Robert Bosch GmbH, Stuttgart (DE)

(21) Appl. No.: 17/045,924

(22) PCT Filed: Feb. 4, 2019
(86) PCT No.: PCT/EP2019/052603

§ 371 Date: Oct. 7, 2020

(30) Foreign Application Priority Data
Apr. 25, 2018 (DE) 10 2018 206 344.3

(51) Int. Cl. B60W 40/08; G05B 15/02; G06Q 50/30; B60W 60/00; G01S 19/42; G06T 7/73; G06K 9/00

(52) U.S. Cl. CPC B60W 40/08; G05B 15/02; G06Q 50/30; B60W 60/001; G01S 19/42; G06T 7/73; G06T 2207/30252; G06Q 2240/00; B60W 2420/42; B60W 2420/52; B60W 2556/45; B60W 2040/0809; G06T 2207/30201; G06K 9/00288

(57) ABSTRACT

A method for passenger recognition by an autonomous vehicle in which a photograph of the person to be transported is transmitted to a central server, an approximate position of the person to be transported is determined, the autonomous vehicle is brought close to the previously determined position, a precise position of the person to be transported is ascertained by sensor equipment internal to the vehicle on the basis of color and texture features and/or on the basis of a way of walking, the identity of the ascertained person to be transported is verified by a facial recognition system, and the autonomous vehicle is positioned in a boarding area of the person to be transported.

### FIELD

The present invention relates to a method for passenger recognition by an autonomous vehicle, and to a vehicle system for carrying out the method.

### BACKGROUND INFORMATION

Due to their many positive properties, autonomous vehicles are becoming increasingly important. Autonomous vehicles are already equipped with a large number of sensors, and make use of sensor data, vehicle cameras, and GPS data to ascertain a suitable and safe trajectory. Designs up to now provide that the driving functions are taken over by autonomous vehicles while the driver is in the vehicle. Alternatively, the autonomous vehicle may also travel a defined stretch without a driver or occupants, for example in order to pick up occupants at a defined starting point, such as a waiting area, and to take them to a defined destination, such as a further waiting area. In large cities, the parking situation is in many locations difficult, so that sometimes long distances have to be traveled by foot between a parking space and the actual destination location. In particular for persons having limited mobility, but also for young families with children, or in the case of a heavy piece of luggage that has to be transported, long distances may represent a significant burden.

An individual picking up of a driver or passenger by an autonomous vehicle at a location that can be variably selected or that changes dynamically is currently not available. In particular, finding and clearly identifying the driver or a particular occupant in a crowd or a group of people at the edge of a roadway presents a particular technical challenge.

### SUMMARY

An object of the present invention includes providing a method and a vehicle system for the precise identification and picking up of the passenger by autonomous vehicles.

This object may be achieved in accordance with example embodiments of the present invention. Advantageous embodiments of the present invention are described herein.

According to an aspect of the present invention, a method is provided for passenger recognition by an autonomous vehicle. In one step, at least one photograph of the person to be transported is transmitted to a central server.

In a further step, an approximate position of the person to be transported is determined.

The autonomous vehicle is guided to the previously determined approximate position of the person to be transported, or is brought close to the position.

Subsequently, or during this, the precise position of the person to be transported is ascertained by sensor equipment internal to the vehicle on the basis of color and texture features and/or on the basis of a way of walking.

Using facial recognition, in a further step, the identity of the ascertained person to be transported is verified.

Finally, the autonomous vehicle is positioned in a boarding area of the person to be transported.

Currently, for the case in which passengers or the driver (in the following, the driver is also regarded as a passenger) get out of or into the vehicle, drivers must wait with their non-autonomous vehicles at areas provided for this purpose, and must wait for the passenger transfer to be completed. For the case of getting into the vehicle, it is standard to wait at previously agreed-upon stopping positions. Here, either the passenger first arrives at the agreed-upon location and waits for the vehicle, or the vehicle arrives at the agreed-upon location before the passenger, and waits for the passenger to arrive. Autonomous driving provides a new dynamic possibility for determining the passenger transfer location, in which the driver can also be transferred or transported as a passenger, and the vehicle can look for the driver autonomously and without a driver.

In the example method according to the present invention, a photograph of the passenger to be picked up is taken, for example using a smart phone and an app, and is transmitted to a central server. With this, the system is informed as to who has to be located or picked up, and what the person looks like. The first picture by the smart phone can also be accomplished using any other camera systems.

If the passenger initiates a pickup process, he can communicate his rough position to the system. Alternatively, the GPS signal of his smart phone can be used to obtain the rough, or approximate, position of the passenger or of the desired location. The autonomous vehicle can move roughly close to the passenger at the specified time.

Onboard sensors, such as cameras, but also cameras external to the vehicle that are also networked to the cloud, may be used to locate the person in the area of the roughly specified position.

In this way, waiting positions can be determined and realized dynamically for a rapid and uncomplicated passenger exchange, or passenger pickup, by an autonomous vehicle. The autonomous vehicle can look for its passengers anywhere and can make transfers without parking. For this purpose, the autonomous vehicle merely needs to stop.

Because the autonomous vehicle finds the passenger or passengers by itself after a rough specification of the search area, the passengers no longer have to wait for the vehicles at previously specified parking spaces. A passenger can for example walk along a street that was previously made known to the system, and the autonomous vehicle will find the passenger by itself and will stop alongside the passenger in order to enable the passenger transfer.

Using a system for recognizing persons, a function can be implemented in an autonomous vehicle or driving system by which, based on an image of the scene, the driver and/or the passengers can be detected, found and located, in order to transmit the exact position for the passenger exchange to the autonomous vehicle. The precise locating of the person to be transported can be accomplished on the basis of color and/or texture features and/or on the basis of a way of walking of the person. For example, in addition to a so-called selfie, a video of the person can be evaluated by a control unit internal or external to the vehicle, and in this way the identity of the person can be ascertained based on movement patterns. In particular, in this way the person to be transported can be identified, and thus also located, within a surrounding environment or a group of persons. For the recognition of persons based on the way of walking, for example machine learning, computer vision, deep learning, and the like can be used.

In addition, through the example method of the present invention, it is possible for persons having limited mobility to be picked up by the autonomous vehicle precisely at the position from which they are no longer able to change their position by themselves.

According to an exemplary embodiment of the method of the present invention, the vehicle-internal sensor system includes at least one camera, a lidar sensor, and/or at least one radar sensor. The vehicle-internal sensor system can also enable a 360° circumferential view. Using the sensor system, the environment can be scanned or searched for color and texture features of the sought passenger.

According to a further exemplary embodiment of the method in accordance with the present invention, the portrait photo of the person to be transported is taken by the person to be transported, using a portable device having picture-taking functions or an app, and is transmitted directly or indirectly to the autonomous vehicle. In this way, it can be communicated to the system which person has to be found and what they look like. The first picture via smart phone can also be taken using other camera systems having higher integrity.

According to a further exemplary embodiment of the method according to the present invention, an approximate determination of the position of the person to be transported can be carried out using access to the GPS data of the portable device having picture-taking functions, or by transmitting a waiting location. The approximate position can be transmitted to the autonomous vehicle by text messages, such as SMS, email, or by voice messages from the passenger to be transported. In this way, the passenger can transmit an address, a street, an environment or surroundings, noticeable features or landmarks, and the like, to the autonomous vehicle as the approximate position. When this transmitted position is reached, a detailed search can be initiated, for example by the vehicle sensor system, and in this way a precise position of the passenger can be ascertained by the autonomous vehicle. Alternatively or in addition, the GPS signal of a portable device of the passenger can be used to obtain the rough location.

In addition, a pre-planned picking up of the passenger can be realized by reading an electronic calendar, in which the autonomous vehicle waits for the passenger at a desired location as a function of defined meeting times.

According to a further exemplary embodiment of the method according to the present invention, the approximate determination of the position of the person to be transported is carried out by an internal control unit or by an external server unit. In this way, the vehicle can perform the required computations itself, using control devices, or can outsource computing-intensive tasks to the external server unit. This can be for example facial recognition using complex algorithms, or an evaluation of extensive image data ascertained outside the vehicle.

According to a further exemplary embodiment of the method according to the present invention, the autonomous vehicle accesses data files of at least one sensor system external to the vehicle in order to ascertain the position of the person to be transported and in order to verify the identity of the ascertained person to be transported. Through networked infrastructure sensor systems and vehicle sensor systems of other vehicles, other autonomous vehicles can in addition be informed about the vehicle that is picking up the passenger, and can adapt their planned trajectories in a timely manner in such a way that a smooth flow of traffic is enabled. In addition, based on such a networking and fusion of the sensors, a data exchange can be realized that enables a faster and/or more precise identification and locating of the passenger.

According to a further exemplary embodiment of the method according to the present invention, the autonomous vehicle is provided with access to data files stored in a cloud for recognition of persons and locating of persons. In this way, the autonomous vehicle can access collected data of other traffic participants or traffic units, and can for example carry out the identification or locating of the passenger.

According to a further exemplary embodiment of the method according to the present invention, the recognition of the person can be carried out on the basis of color and texture features and facial recognition by an external server unit or by a control unit internal to the vehicle. In this way, computing-intensive steps of the method can be outsourced to stationary computing units of the external server unit, so that the vehicle-internal control units can be designed to be less powerful. As a result, the vehicle can be outfitted with equipment at lower cost.

According to a further exemplary embodiment of the method according to the present invention, the autonomous vehicle is provided with access to sensors and search functions and/or data exchange with stored data of other vehicles, for recognition of persons and locating of persons.

As sensors for the detection, recognition, and locating of the person, primarily onboard cameras of the vehicle may be used.

Alternatively or in addition, external video monitoring cameras (e.g., on light poles or on building walls) may be used in the method. Likewise, in a further development, various networked collaborating vehicles can together send their sensor data to a cloud in order to recognize persons for whom none of them has any driving requests, thus contributing to an optimized stability of the system.

According to a further exemplary embodiment of the method according to the present invention, the person to be transported is informed if the person is not found by the autonomous vehicle. If the identification and locating of the passenger by the autonomous vehicle is terminated, or has an error, in this way a message can preferably be sent to the passenger. Subsequently, a new approximate position can be transmitted to the vehicle by the passenger, whereupon the method can be at least partly carried out again by the vehicle.

According to a further aspect of the present invention, a vehicle system is provided for carrying out the method according to the present invention. The vehicle system has at least one autonomous vehicle having a vehicle sensor system and a control unit internal to the vehicle. In addition, the vehicle system has a server unit external to the vehicle. Via communication units, the at least one autonomous vehicle can set up a data-transmitting communication connection with the server unit. In addition, the vehicle system can have an optionally usable infrastructure sensor system that can be evaluated by the server unit.

Below, preferred exemplary embodiments of the present invention are explained in more detail on the basis of highly simplified schematic figures.

### BRIEF DESCRIPTION OF THE DRAWINGS

FIG. 1 shows a schematic flow diagram illustrating a method according to the present invention according to a specific embodiment.

FIG. 2 shows a schematic top view of a vehicle system according to the present invention, in a specific embodiment.

In the Figures, identical constructive elements are provided with the same reference characters in each case.

### DETAILED DESCRIPTION OF EXAMPLE EMBODIMENTS

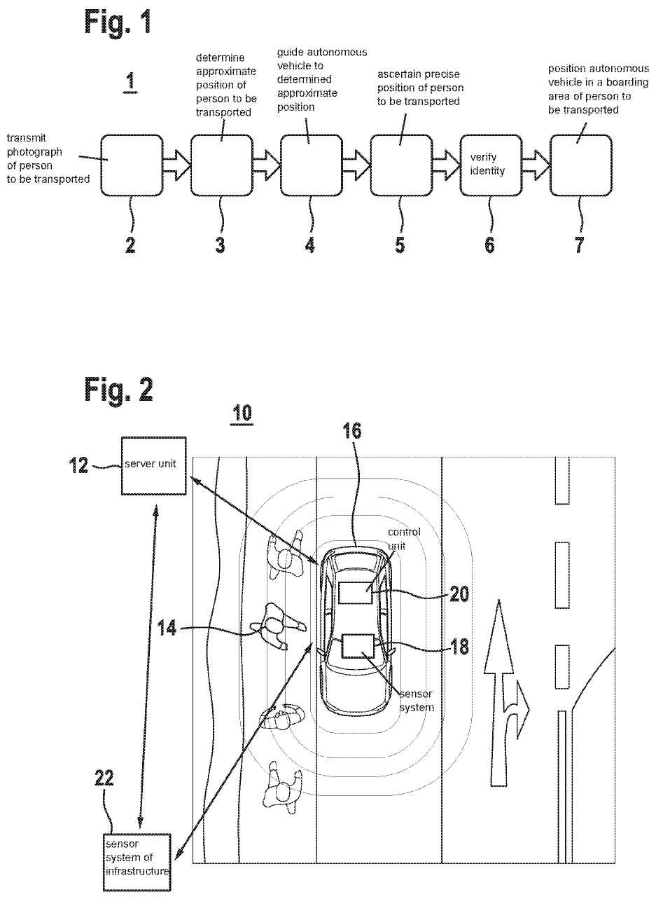

FIG. 1 shows a schematic flow diagram illustrating a method 1 according to the present invention, in a specific embodiment. The structural features relate to a vehicle system 10 according to the present invention that is shown in FIG. 2.

In a step 2, at least one photograph of a person to be transported is transmitted to a central server 12 of a vehicle system 10. This may be for example a so-called selfie of a passenger 14, transmitted to a cloud 12 or to a server unit 12 external to the vehicle. In external server unit 12, recognition data of person 14 can be generated. These may be structural or textural features.

In a further step 3, an approximate position of person 14 to be transported is determined. The approximate position may be for example a street or a surrounding environment of person 14 at which the person is to be picked up by an autonomous vehicle 16. The approximate position can be ascertained for example using a GPS signal of a portable device of passenger 14. However, with non-military use of GPS sensors there may be an imprecision of at least a few meters, which may be more pronounced due to particular local conditions.

In a further step 4, autonomous vehicle 16 is guided to the previously determined approximate position of person 14 to be transported, or is brought close to the position.

Subsequently 5, or during this, the precise position of person 14 to be transported is ascertained by sensor system 18 internal to the vehicle, using color and texture features. Sensor system 18 is coupled to a control unit 20 inside the vehicle, and can be evaluated by control unit 20. In addition, control unit 20 has a communication device (not shown) by which a wireless communication connection can be created to external server unit 12.

Server unit 12 here also communicates with a sensor system of infrastructure 22, and can read and evaluate it. The communication connections are illustrated by arrows.

In a further step 6, the identity of the ascertained person 14 to be transported is verified by facial recognition.

Finally 7, autonomous vehicle 16 is positioned in a boarding area of person 14 to be transported.

In the following, a specific embodiment of method 1 according to the present invention is described in detail.

For the detection, recognition, and locating of passenger 14, methods from the domains of computer vision, machine learning, and artificial intelligence may be used. The method is divided into two regions: a near region and a far region.

The near region is the region in which the face of passenger 14 is close enough to the camera, or to a vehicle sensor system 18, that a facial recognition method can be used. Within this region, the probability of not confusing person 14 with someone else is very high.

The far region is the region in which the face of passenger 14 is far enough away from camera 18 that a facial recognition method cannot be used. In the far region, color and texture features from the images are used to recognize the person. In the far region, system 10 has to take a plurality of possible passengers into account, depending on the density of persons in the scene, until recognition in the near region is possible.

After the successful locating of passenger 14, the autonomous vehicle can adapt its target trajectory so as to position itself alongside passenger 14 in such a way that the door provided for the passenger comes to be situated directly next to passenger 14, and passenger 14 can easily get into vehicle 16.

For the case in which vehicle 16 can at no time acquire passenger 14 in the near region, it is possible, using a back-channel to the smart phone of passenger 14, to ask the passenger to look in the direction of the street so that his or her face can be recognized.

Once passenger 14 has been picked up, vehicle 16 resumes travel so as not to block traffic for an unnecessarily long time.

1-11. (canceled)

12. A method for passenger recognition by an autonomous vehicle, the method comprising the following steps:
transmitting to a central server a photograph of a person to be transported;
determining an approximate position of the person to be transported;
approaching by the autonomous vehicle to the determined approximate position;
ascertaining a precise position of the person to be transported based on color and texture features and/or on based on a way of walking, using sensor equipment internal to the autonomous vehicle;
verifying, using facial recognition, an identity of the person to be transported whose precise position was ascertained; and
positioning the autonomous vehicle in a boarding area of the person to be transported.

13. The method as recited in claim 12, wherein the sensor equipment internal to the autonomous vehicle includes at least one camera, and/or at least one lidar sensor, and/or at least one radar sensor.

14. The method as recited in claim 12, wherein the photograph of the person to be transported is taken and transmitted by the person to be transported, using a portable device having picture-recording functions or an app.

15. The method as recited in claim 14, wherein the determination of the approximate position of the person to be transported is carried out via an access to GPS data of the portable device having picture-recording functions, or by transmission of a waiting location.

16. The method as recited in claim 12, the determination of the approximate position of the person to be transported is carried out by an internal control unit of the autonomous vehicle or by an external server unit.

17. The method as recited in claim 12, wherein the autonomous vehicle accesses data files of at least one sensor system external to the vehicle for the ascertaining of the position of the person to be transported and for the verifying of the identity of the ascertained person to be transported.

18. The method as recited in claim 17, wherein access is provided for the autonomous vehicle to data files stored in a cloud for recognition of the person to be transported and locating of the person to be transported.

19. The method as recited in claim 17, wherein recognition of the person to be transported is carried out based on color and texture features and a facial recognition by an external server unit or by a control unit internal to the vehicle.

20. The method as recited in claim 17, wherein access to sensors and/or search functions and/or data exchange with stored data of other vehicles is provided for the autonomous vehicle for recognition of the person to be transported and locating of the person to be transported.

21. The method as recited in claim 12, further comprising the following step:
informing the person to be transported in the case of the person to be transported not being found by the autonomous vehicle.

22. A vehicle system for passenger recognition by an autonomous vehicle, the vehicle system configured to:
transmit to a central server a photograph of a person to be transported;
determine an approximate position of the person to be transported;
cause the autonomous vehicle to approach the determined approximate position;
ascertain a precise position of the person to be transported based on color and texture features and/or on based on a way of walking, using sensor equipment internal to the autonomous vehicle;
verify, using facial recognition, an identity of the person to be transported whose precise position was ascertained; and
position the autonomous vehicle in a boarding area of the person to be transported.
